(19) United States
(12) Patent Application Publication
(10) Pub. No.: US 2016/0124899 A1
(43) Pub. Date: May 5, 2016

(54) MULTI-CHIP PACKAGED FUNCTION INCLUDING A PROGRAMMABLE DEVICE AND A FIXED FUNCTION DIE AND USE FOR APPLICATION ACCELERATION

(71) Applicant: eASIC Corporation, Santa Clara, CA (US)

(72) Inventors: Ronnie VASISHTA, Mountain View, CA (US); Ban P. WONG, Milpitas, CA (US)

(21) Appl. No.: 14/719,430

(22) Filed: May 22, 2015

Related U.S. Application Data
(60) Provisional application No. 62/074,978, filed on Nov. 4, 2014.

(51) Int. Cl. G06F 15/78; G06F 9/38

(52) U.S. Cl. CPC G06F 15/7817; G06F 9/3889; G06F 15/7853; G06F 9/3877; G06F 15/7889

(57) ABSTRACT

One or more processing functions may be off-loaded from a general-purpose processing device to auxiliary processing devices. The auxiliary processing devices may include a programmable element and a fixed-function element that may be pre-configured to perform the one or more processing functions. The programmable element and the fixed-function element may be dies of a multi-chip module (MOM) in a common package that can contain the general-purpose processing device, or the general-purpose processing device may reside outside of the MOM.

### CROSS-REFERENCE TO RELATED APPLICATION

This application is a U.S. non-provisional patent application claiming priority to U.S. Provisional Patent Application No. 62/074,978, filed on Nov. 4, 2014, and incorporated herein by reference.

### FIELD OF ENDEAVOR

Various aspects of the present disclosure may relate to acceleration functionality and devices, and more specifically, but not exclusively, to compute server, cloud compute server or Cloud Radio Access Network (CRAN) baseband function acceleration.

### DESCRIPTION OF THE RELATED ART

This section introduces aspects that may help facilitate a better understanding of the invention. Accordingly, the statements of this section are to be read in this light and are not to be understood as admissions about what is prior art or what is not prior art.

Baseband communication processing running on commercial servers on one or more general-purpose central processing units (CPUs) may be inefficient, as well as power hungry, for example, if they are to service the real-time computational requirements of remote radio heads (RRHs). Therefore, it may be desirable to have a way to accelerate such processing, as well as other types of processing.

### SUMMARY OF ASPECTS OF THE DISCLOSURE

According to various aspects of this disclosure, the off-loading of computational effort to a computing accelerator, which may be optimized for digital signal processing (DSP)-type computation may be used to significantly improve processing speed while reducing the power requirements.

The off-loading of the computing effort from a general purpose CPU (and/or network processing unit (NPU) and/or general-purpose graphical processing unit (GPU)) to compute one or more algorithms, which may include, but are not limited to, encryption, compression, search algorithms (which may be, for example, proprietary search algorithms), financial calculations and/or storage management may be used to significantly improve computational speed while at the same time, also reducing the power requirements.

The computing accelerator may include a logic programmable portion, a non-programmable portion, or both. These may be contained within a common semiconductor package. According to an aspect of this disclosure, the computing accelerator may be contained in a multi-chip package that may contain a programmable portion, a fixed-function portion and a processor.

### BRIEF DESCRIPTION OF THE DRAWINGS

Various aspects of the present disclosure will now be presented in detail in conjunction with the accompanying drawings, in which:

FIG. 1 shows a conceptual block diagram of an example device according to an aspect of this disclosure and an example of how it may be used; and

FIG. 2 shows a further conceptual block diagram of an example device according to an aspect of this disclosure and how it may be used.

### DETAILED DESCRIPTION

According to certain aspects of the present disclosure, a device with an appropriate set of functions may be used to: 1. off-load at least some of the baseband processing effort from the traditional commercial servers that service the RRHs; or 2. off-load at least some of the computing effort from the traditional commercial servers that service data centers or server farms. Other similar applications, in which specialized computing-intensive functions may be off-loaded to an auxiliary device according to an aspect of this disclosure, are also contemplated.

More particularly, aspects of the present disclosure describe a examples of a heterogenous computing architecture where the strength of different computing architectures may be combined to offer improved performance for different types of processing at a fraction of the power of a homogeneous processing system. With an attached programmable element, further tailoring of the compute capability may be possible for the functional units deployed in the compute acceleration. The programmable element can also be deployed to track protocol changes in certain applications.

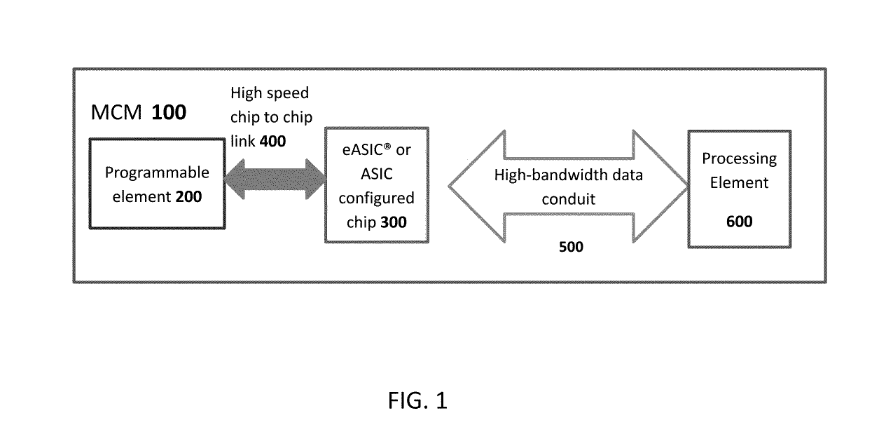

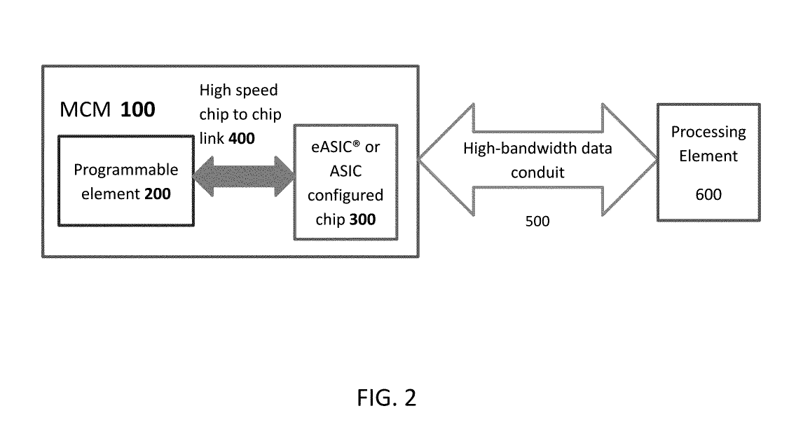

FIG. 1 shows a conceptual block diagram of one example of such a device. In the example of FIG. 1, a multi-die packaged function (denoted in FIG. 1 as multi-chip module (MOM) 100, but not necessarily limited thereto) may include a programmable element 200 and a fixed-function element 300, and may also potentially include a processing element 600. In the example of FIG. 2, the processing element 600 may, alternatively, be external to MOM 100. Alternatively, there may be processing elements 600 located both internally, as in FIG. 1, and externally, as in FIG. 2, to the MOM 100. Programmable element 200 may be, for example, be a block static random-access memory (SRAM) that may be configured as a lookup table to enable specialized functions through an internal network or from external data sources. This element 200 may also be in the form of one-time programmable (OTP) read-only memory (ROM) that may be coupled to other devices, e.g., eASIC® eCells, for yet other acceleration functions that were not anticipated during manufacture of the device. The OTP ROM may, for example, be configured in three copies to allow three times reprogrammability. The fixed-function element 300 may be, for example, but is not limited to, an application-specific integrated circuit ASIC or a configurable logic circuit (e.g., a configurable logic circuit of a type made by eASIC® Corporation, which may include at least one via-configurable circuit) that has been configured to have particular functionality. The MOM 100 may be designed to provide application acceleration when combined with a processing element 600 (e.g., but not limited to, a central processing unit (CPU), a graphical processing unit (GPU), a network processing unit (NPU) or a baseband processor) outside or inside of the MOM 100. The MOM 100 may provide capabilities for performing functions or computations that may normally be performed in the processor 600, which may allow the processor 600 to off-load such functions or computations to resources within the combination of the programmable element 200 and the fixed function element 300, which may be able to perform them more quickly and/or efficiently than the processor 600 alone and/or may also be used to free the resources of the processor 600 to perform further functions and/or computations.

The MOM 100 may generally be pre-configured to perform the off-loaded functions or computations. This may be done by pre-programming or reprogramming the programmable element 200 and/or by means of the configuration of the fixed-function element 300. The reprogrammability of the MOM 100 may extend the functional capabilities of the MOM 100.

The programmable element 200 may be interconnected to the fixed-function element 300, and also to the processing element 600, if the processing element 600 is inside the MOM 100, through a high-speed chip-to-chip link 400, through which data and/or control information may be exchanged between the programmable element 200 and the fixed-function element 300 and/or the processing element 600. A data conduit 500, which may be a high-bandwidth data conduit, may be used to connect the MOM 100 to the processing element 600 if the processing element 600 is outside the MOM 100, which may enable communication of data and/or instructions between the MOM 100 and the processing element 600.

As noted previously, MOM 100 and processing element 600 may communicate with each other via data conduit 500. Such communication may include transfers of data and/or control information (such as, but not limited to, flags, settings, or the like and/or timing information).

Use of the MOM 100 to off-load various functions may provide improved performance per unit power, in comparison with what may be achievable by the general purpose processing element 600 alone, when performing these functions. Additionally, the use of the programmable element 200 within the MOM 100 may enable functional programmability that may be used to track protocol or algorithm changes as well as extending functional capabilities.

The use of a fixed-function element 300 for DSP or other off-load functions may enhance performance per unit power in DSP-intensive applications. Off-loading the DSP or algorithm computing effort into the MOM 100 may help improve the power-consumption and may enhance the performance envelope of the server or a baseband processor as compared to those systems that utilize DSP software running exclusively on general purpose processors, such as those mentioned above.

Various aspects of this disclosure have been presented above. However, the invention is not intended to be limited to the specific aspects presented, which have been presented for purposes of illustration. Rather, the invention extends to functional equivalents as would be within the scope of the appended claims. Those skilled in the art, having the benefit of the teachings of this specification, may make numerous modifications without departing from the scope and spirit of the invention in its various aspects.

What is claimed is:

1. An auxiliary processing device including:
a programmable component; and
a fixed-function component,
wherein the programmable component and the fixed-function component are disposed within a common semiconductor package, and
wherein the auxiliary processing device is configured to communicate with an external processing device to enable the external processing device to off-load one or more processing functions to the auxiliary processing device, for which one or more processing functions the programmable component and the fixed-function component are pre-configured.

2. The auxiliary processing device according to claim 1, wherein the auxiliary processing device is configured as a multi-chip module.

3. The auxiliary processing device according to claim 1, further including at least one interconnection between the programmable component and the fixed-function component.

4. The auxiliary processing device according to claim 1, wherein the fixed-function component comprises an application-specific integrated circuit (ASIC).

5. The auxiliary processing device according to claim 1, wherein the fixed-function component comprises a pre-configured configurable logic device.

6. The auxiliary processing device according to claim 2, wherein the pre-configured configurable logic device comprises a via-configurable logic device.

7. The auxiliary processing device according to claim 1, wherein the auxiliary processing device is pre-configured to perform one or more baseband communication signal processing functions.

8. The auxiliary processing device according to claim 1, wherein the auxiliary processing device is pre-configured to perform one or more functions to enable off-loading of the one or more functions from one or more servers that service data centers or server farms, or which are cloud servers.

9. The auxiliary processing device according to claim 1, wherein the auxiliary processing device is configured to be communicatively coupled to the external processing device by a high-bandwidth data conduit.

10. A system including:
one or more processing devices; and
the auxiliary processing device according to claim 1, wherein the auxiliary processing device according to claim 1 is communicatively coupled to at least one of the one or more processing devices as the external processing device.

11. A method of processing data, the method including:
off-loading one or more processing functions to the auxiliary processing device according to claim 1.

12. A processing device including:
a programmable component;
a fixed-function component; and
a general-purpose processor component,
wherein the programmable component, the fixed-function component and the general-purpose processor component are disposed within a common semiconductor package, and
wherein the combination of the programmable component and the fixed-function component is communicatively coupled to the general-purpose processor component and is configured to enable the general-purpose processor component to off-load one or more processing functions to the combination of the programmable component and the fixed-function component, for which one or more processing functions the combination of the programmable component and the fixed-function component is pre-configured.

13. The processing device of claim 12, wherein the common semiconductor package is a multi-chip module.

14. The processing device according to claim 12, further including at least one interconnection between the programmable component and the fixed-function component.

15. The processing device according to claim 12, wherein the fixed-function component comprises an application-specific integrated circuit (ASIC).

16. The processing device according to claim 12, wherein the fixed-function component comprises a pre-configured configurable logic device.

17. The processing device according to claim 16, wherein the pre-configured configurable logic device comprises a via-configurable logic device.

18. The processing device according to claim 12, wherein the combination of the programmable component and the fixed-function component is pre-configured to perform one or more baseband communication signal processing functions.

19. The processing device according to claim 12, wherein the combination of the programmable component and the fixed-function component is pre-configured to perform one or more functions to enable off-loading of the one or more functions associated with one or more servers that service data centers or server farms, or which are cloud servers.

20. A method of processing data, the method including:
off-loading one or more processing functions from the general-purpose processor component to the combination of the programmable component and the fixed function component in the processing device according to claim 12.
